(19) United States
(12) Patent Application Publication
(10) Pub. No.: US 2023/0419378 A1
(43) Pub. Date: Dec. 28, 2023

(54) QUANTUM ACCURACY SCORE

(71) Applicant: Dell Products L.P., Round Rock, TX (US)

(72) Inventors: Kenneth Durazzo, Morgan Hill, CA (US); Stephen J. Todd, North Andover, MA (US); Michael Robillard, Shrewsbury, MA (US); Victor Fong, Melrose, MA (US); Brendan Burns Healy, Whitefish Bay, WI (US); Benjamin E. Santaus, Somerville, MA (US); Eric Bruno, Shirley, NY (US)

(21) Appl. No.: 17/809,087

(22) Filed: Jun. 27, 2022

(51) Int. Cl. G06Q 30/0601

(52) U.S. Cl. CPC G06Q 30/0609; G06Q 30/0627

(57) ABSTRACT

One example method includes receiving job configuration information from a user with a quantum computing job to be performed, receiving quantum computing information from a quantum computing service vendor, generating, based on the quantum computing information, a vendor score for the quantum computing service vendor, and transmitting the vendor score to the user. The quantum computing information received from the quantum computing service vendor may include information about an accuracy of results produced by execution of a quantum circuit or other quantum hardware operated by the quantum computing service vendor.

### FIELD OF THE INVENTION

Embodiments of the present invention generally relate to processes performed by quantum circuits. More particularly, at least some embodiments of the invention relate to systems, hardware, software, computer-readable media, and methods for evaluating the performance of quantum circuits that implement quantum processes.

### BACKGROUND

Quantum execution, and quantum simulation, are inherently probabilistic processes. Unlike classical computing processes, the output of a quantum circuit evaluation is typically considered to be only an approximation, albeit an approximation that is often, but not always, accurate. At present however, it is difficult to evaluate a quantum circuit in a way that will provide useful results.

For example, there is currently no metric to quantify trust in the quantum vendor regarding the quantum hardware that ran a requested job. As another example, and due to conflicts-of-interest by QPU (quantum processing unit) providers, the QPU providers are not able to report a “vendor accuracy” score to the end user which may be compared against the scores of other vendors. Further, the intricate statistics behind quantum computation are not intuitive and are difficult to calculate. Finally, when billing a user, it is difficult for the user to receive an audit record containing the accuracy to prove that they got what they paid for in terms of quantum process/circuit performance.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture according to some embodiments.

FIG. 2 discloses aspects of an example configuration showing various example uses of quantum computing information.

FIG. 3 discloses an example method according to some embodiments.

FIG. 4 discloses an example computing entity operable to perform any of the claimed methods, processes, and operations.

### DETAILED DESCRIPTION OF SOME EXAMPLE EMBODIMENTS

Embodiments of the present invention generally relate to processes performed by quantum circuits. More particularly, at least some embodiments of the invention relate to systems, hardware, software, computer-readable media, and methods for evaluating the performance of quantum circuits that implement quantum processes.

In light of problems such as those noted earlier herein, it may be desirable to provide an end user of QPU-as-a-service (QPUaaS) some metric(s) that the user can use to judge the accuracy of the performance of a quantum circuit such as a QPU or vQPU (virtual QPU). This metric may consider factors such as, but not limited to, the number of shots, QPU error rate, vendor score, and others. With information about the accuracy of quantum circuit outputs, the user may be able to assess the relative performance and, thus, the value, of the quantum hardware of one QPUaaS provider against the quantum hardware of one or more other QPUaaS providers. Put another way, an embodiment may enable a user to measure a level of confidence in a quantum machine that provides quantum computing functionality to the user.

In one example embodiment, a quantum orchestrator, which may have access both to a variety of different quantum service providers, as well as access to the configuration data provided by the job requester such as number of shots, error rate, and vendor score, for example, may apply a deterministic algorithm to these data and produces a score. This score may be presented to the end-user prior to the user formally requesting and purchasing the compute services from a quantum service provider, in order to help the user determine the value of the result they can get, when adjusting parameters that may impact price, such as number of shots for example, from that vendor. The outcome of the circuit execution may be stored for later analysis by an ML model, configured and operable to improve and refine the deterministic algorithm. The user may also choose to provide a subjective rating of the result which may enable the orchestrator to predict user satisfaction in future jobs. Finally, the accuracy score may be used as a confidence criteria such as may be employed in connection with a DCF (data confidence fabric).

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may enable a user to compare the relative performance of different quantum computing service providers before committing to purchase services from those providers. An embodiment may generate information that may be used in assessing the confidence in data pipeline elements in a DCF. An embodiment may operate to perceive, and learn about, a relation between quantum execution by quantum hardware, and user satisfaction with the results of the quantum execution. An embodiment may be able to distinguish, in the context of quantum hardware operations, error that results from inherent probabilistic noise of the quantum operations, and error that results from quantum hardware limitations. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. ASPECTS OF AN EXAMPLE ARCHITECTURE AND ENVIRONMENT

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, any of which may be quantum and/or classical in nature. Note that as used herein, ‘classical’ computing processes, systems, and components, embrace, but are not limited to, processes, systems and components that do not employ quantum circuits or quantum processes. Quantum processes, systems, and components, may employ quantum circuits that include one or more quantum components, and perform quantum computing processes with those quantum circuits.

A.1 User Quantum Computing Jobs

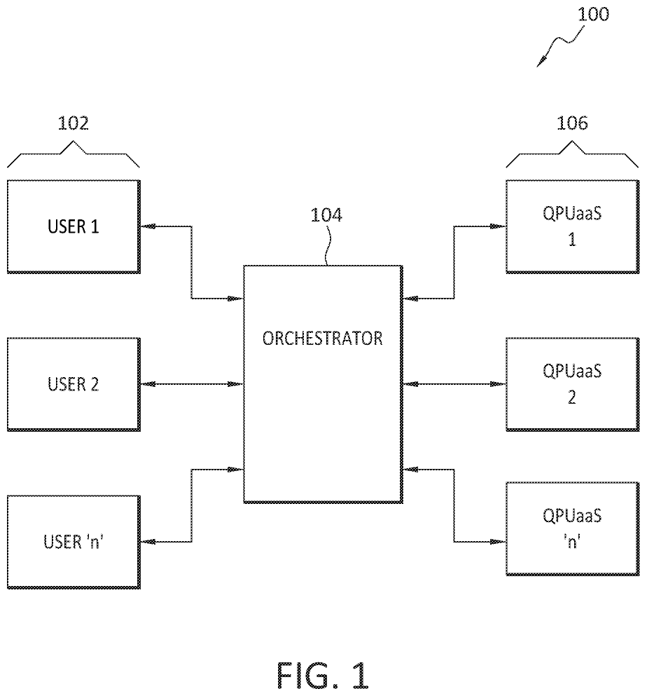

With particular attention now to FIG. 1, one example of an operating environment for embodiments of the invention is denoted generally at 100. In general, the operating environment 100 may include any number ‘n’ of users 102. In general, the users 102 may comprise any entity that has a need for quantum computing services. Thus, any of the users 102 may be human, a business entity such as a company, an AI (artificial intelligence), or any other entity with a need for quantum computing services.

Any or all of the users 102 may define and/or specify a job configuration concerning a quantum computing job that is needed by the user 102 to be performed. A job configuration may comprise various parameters relating to the quantum computing services that are needed. Such parameters may comprise, but are not limited to, the number of shots, acceptable error rate—or ‘accuracy’—for a quantum machine output, and minimum acceptable vendor score. As well, any other parameter(s) that may enable a user 102 to assess the performance of a quantum machine and/or service provided by a quantum vendor may likewise be employed. As discussed below, these parameters and/or other parameters may be used to enable a user to determine a vendor score that may be compared with respective scores of one or more other vendors.

A.2 Orchestrator

As shown in FIG. 1, the example operating environment 100 may include an orchestrator 104 which may or may not be hosted at the same site as one or more of the users 102. Among other things, the orchestrator 104 may receive, from one or more of the users 102, values for various parameters relating to quantum computing services that may be needed by the users 102. The orchestrator 104 may include a database that may be used to store the information received from the users 102.

With regard to the input that may be provided by a user 102 and/or a quantum computing service provider 106, and processed by an orchestrator 104, it is noted that quantum computing is probabilistic in nature. Thus, each execution of a quantum circuit may only calculate a state (Qubit #1 measured as 1, and Qubit #2 measured as 0, for example). The execution may require repeated executions, that is, shots, of the same circuits. The number of shots required to approximate the idealized probability distribution may depends on considerations such as the number of qubits, number of gates and entanglement of the circuit. The result of a quantum computing process may thus comprise a sampling from the probabilistic distribution for all the qubits (Qubit #1 65%, Qubit #2 25%, for example). Finally, it is noted that QPU vendors, such as the quantum computing service provider 106, and QPU models may differ from one another in various respects such as, but not limited to, clock speed, error rate, qubit volume, and entanglement characteristics, that is, how many qubits can be entangled, for example.

With continued reference to the example of FIG. 1, the orchestrator 104 may comprise a scoring algorithm, which may be deterministic in nature, that may be used to generate a vendor score based on the job configuration input received from the user(s) 102. In some embodiments, the orchestrator 104 may present, such as by way of a suitable UI (user interface) a wizard, or website, by way of which the user 102 may define a job configuration.

A vendor score may be generated by the orchestrator 104 on a prospective basis, that is, before the user 102 has actually requested and/or purchased computing services from a quantum computing service vendor 106, which may be referred to herein as a ‘quantum vendor.’ In this way, a user 102 may be able to request, and receive, respective vendor scores from the orchestrator 104 for each of one or more quantum computing service vendors 106. The quantum computing service vendors 106 may each be associated with, and control the operation of, respective quantum hardware such as QPUs, and quantum software, either or both of which may be used to perform quantum computing services for a vendor 102.

The user 102 may then compare the vendor scores and make a determination, based on this comparison, as to which quantum computing service vendor 106 should be requested to perform the quantum computing services needed by the user 102. A request by a user 102 for quantum computing services from one or more of the quantum computing service vendors 106 may or may not be transmitted from the user 102 to the quantum computing service vendor 106 by way of the orchestrator 104.

Note that the selection of a particular quantum computing service vendor 106 may not be made solely on a vendor score but may additionally, or alternatively, based on an expected cost of the quantum computing services requested. For example, the cost model for some quantum service provider may comprise a base cost+number of shots per quantum circuit execution, such as may be found, for example, in Amazon AWS Bracket. The cost model may be different from other accelerators, which may typically charge by the hour and need to be added to the pricing model of a compute instance, such as in the case of Amazon AWS ECS.

As noted above, the orchestrator 104 may or may not be hosted at the same site as one or more of the users 102. In some embodiments, the orchestrator 104 may be implemented as a stand-alone platform that is operable to communicate with the users 102 and the quantum computing service vendors 106. However it is implemented, the functions implemented by the orchestrator 104 may be made available, such as on a subscription or other basis, to one or more users 102 as-a-Service, that is, Orchestration as a Service (OaaS). No particular implementation of the orchestrator 104 is required however.

With continued attention to FIG. 1, the orchestrator 104 may, in addition to communicating with the users 102, also communicate with the quantum computing service vendors 106, any one or more of which may local to, or remote from, any of the users 102 and/or the orchestrator 104. In some embodiments, one or more of the quantum computing service vendors 106 may provide quantum computing-as-a service, which may be referred to herein as QPUaaS (Quantum Processing Unit(s) as a Service), to which a user 102 may subscribe on a recurring, or ad hoc, basis.

Based on the job configuration input received from the user(s) 102, the orchestrator 104 may, in response, request various information from one or more of the quantum computing service vendors 106. In some embodiments, the information is requested only from quantum computing service vendor(s) 106 specifically identified by a user 102 in its request to the orchestrator 104. The information requested by the orchestrator 104 from the quantum computing service vendor(s) 106 may correspond to the parameters included in the job configuration defined by, and received by the orchestrator 104 from, the user(s) 102. Thus, the orchestrator 104 may request that a quantum computing service vendor 106 provide information such as, but not limited to, the number of shots needed to achieve a particular output by a quantum circuit, and a OD QPU error rate.

The information received by the orchestrator 104 from the quantum computing service vendor 106 may then be provided as input to the deterministic algorithm of the orchestrator 104, and a respective vendor score generated by the orchestrator 104 for each quantum computing service vendor 106 from which information was received by the orchestrator 104. These vendor scores may then be returned by the orchestrator 104 to the requesting user(s) 102, which may then use the vendor scores as a basis to select one or more computing service vendors 106 for the provisioning of quantum computing services to carry out the job that corresponds to the job configuration defined by the user 102.

In some embodiments, the orchestrator 104 may periodically, and automatically, query one or more of the quantum computing service vendors 106 and automatically generate updated vendor scores based on information received from the quantum computing service vendors 106 in response to the query. The updated vendor scores may then be automatically transmitted by the orchestrator 104 to the user(s) 102 to which the vendor scores apply. In this way, a user 102 may be timely and automatically apprised of any changes in the performance of one or more quantum computing service vendors 106. A change in vendor score may be used by the user 102 as a basis for selecting and/or de-selecting one or more quantum computing service vendors 106 to perform services for the user 102. For example, if an updated vendor score indicates that the performance of a particular quantum computing service vendor 106 no longer complies with the requirements of a user 102, the user 102 may choose to use a different quantum computing service vendor 106 to serve the quantum computing needs of the user 102.

Vendor scores generated by the orchestrator 104 may also be provided to the quantum computing service vendors 106 so that they can see how they match up against the other quantum computing service vendors 106. By accessing the vendor scores, under-performing quantum computing service vendors 106 may be incentivized to improve their performance and thereby enhance their competitiveness relative to other quantum computing service vendors 106.

Finally, a user 102 may provide a subjective rating of a vendor score. This subjective rating may be used by the orchestrator 104 to predict user satisfaction regarding the performance of future jobs by one or more of the quantum computing service vendors 106.

A.3 Post-Performance Evaluation

As discussed above, a user 102 may request the generation of a vendor score concerning a quantum computing service vendor 106 prior to selecting a quantum computing service vendor 106 for provision of quantum computing services to the user 102. The user 102 may use the vendor score to select a quantum computing service vendor 106 that will provide services to the user 102.

Embodiments of the invention may also provide for after-the-fact analysis, such as by a deterministic algorithm of the orchestrator 104 for example, of the performance of a quantum machine or equipment of a quantum computing service vendor 106. The outcome of this analysis, like the vendor score, may be used by a user 102 to make future decisions regarding selection of a quantum computing service vendor 106. The analysis of the performance of a quantum machine may be performed by an ML (machine learning) model that may operate to improve, and refine, the performance of the deterministic algorithm. Improvements to the performance of the deterministic algorithm may be beneficial both to users 102, and to quantum computing service vendor 106.

It is noted that as used herein, the ‘performance’ of a quantum computing service vendor 106 may include, but is not limited to, the performance of quantum hardware/machines and quantum software operated by that quantum computing service vendor 106. The performance may be expressed as disclosed herein, such as in terms of vendor error rate for example, and/or in any other suitable way.

### B. FURTHER ASPECTS OF SOME EXAMPLE EMBODIMENTS

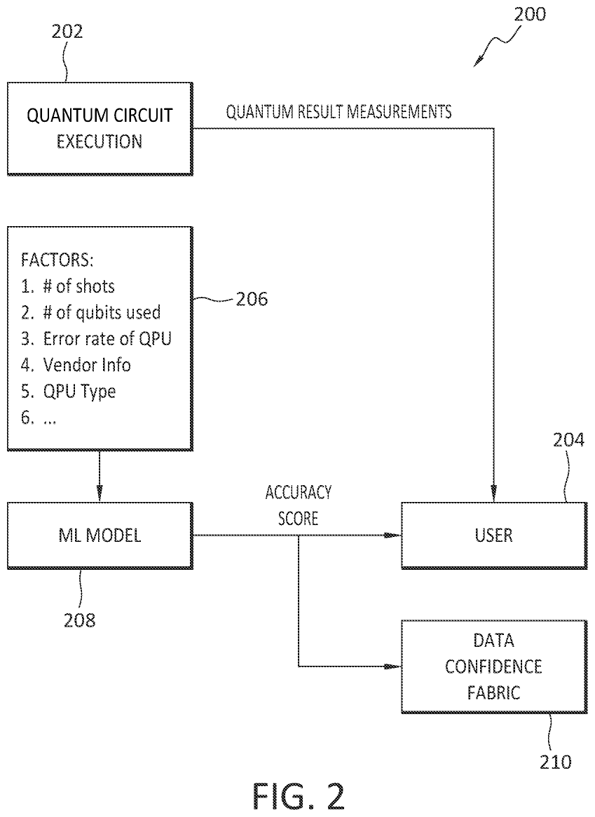

With reference now to FIG. 2, and continued reference to FIG. 1, further details are provided concerning various operation aspects of some example embodiments of the invention. In the example configuration 200 of FIG. 2, the results of a quantum circuit execution 202, such as by a quantum computing service vendor for example, may be fed directly, or indirectly such as by way of an orchestrator, to a user 204. In some embodiments, such results may comprise raw data that has not been processed by an orchestrator or by a quantum computing service vendor.

The results may include, for example, values for various factors 206 which may or may not be specified by a user. For example, a user may specify the factors 206 as being of interest, and information, such as may be received from a quantum computing service vendor, corresponding to those factors 206 may be processed by a deterministic algorithm of an orchestrator. The deterministic algorithm may comprise, and/or be refined by, an ML model 208. An output of the deterministic algorithm and/or of the ML model 208 may comprise an accuracy score that comprises a relative indication of how closely the operation of a quantum circuit or quantum machine, such as a QPU, confirms with a standard specified by a user, or by industry.

The accuracy score may be provided to the user 204, either directly or by way of an orchestrator. Additionally, or alternatively, the accuracy score may be provided as an input to a DCF (data confidence fabric) 210. In general, a DCF may comprise a number of nodes that each handle data passing through the DCF. The overall ‘confidence’ in, or of, a DCF may reflect confidence in the way in which the DCF nodes handle the data as the data traverses the DCF, and/or confidence in the accuracy and trustworthiness of the data itself. In either case, the accuracy score, to the extent it reflects confidence in the operation of quantum hardware and/or confidence in the output of the quantum hardware, may comprise an element to be considered when generating an overall confidence score for the DCF 210. The relative contribution, to an overall DCF confidence score, of an accuracy score may be expressed numerically. For example, an accuracy score might have a weight of 6/10 of the overall DCF score. The confidence in the operation of quantum hardware and/or confidence in the output of the quantum hardware, may be considered by a user in making decisions about choosing a quantum services provider, specifying a number of shots, and other choices to be made in a process for requesting quantum computing services.

### C. FURTHER DISCUSSION

As will be apparent from this disclosure, example embodiments may possess various useful features and advantages. For example, an embodiment may provide for accuracy score calculation and usage in data confidence fabric to produce overall confidence score in an end-to-end data pipeline. An embodiment may employ an accuracy score as a factor in a global optimization process to best select a local or remote QPU vendor. An embodiment may make use of statistical modeling, which may be implemented in an orchestrator, deterministic algorithm, and/or in an ML model, to disambiguate error which comes from inherent probabilistic noise of a quantum process, and error which comes from actual hardware limitations. The specifications of any QPU include some amount of “noise” which can be expected, and hardware which is substandard with respect to the quantum computer requested may be determined at a statistically significant rate. An embodiment may comprise an ML model which may learn about a relationship between quantum execution and user satisfaction with the results of the quantum execution.

### D. EXAMPLE METHODS

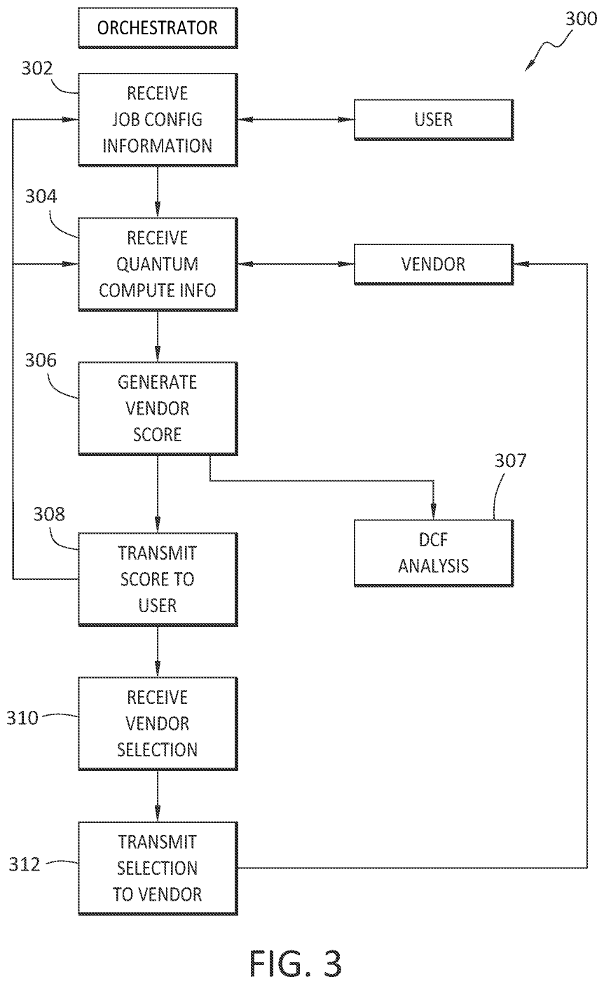

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method according to some embodiments is generally denoted at 300. The example method 300, some or all of which may be performed by an orchestrator that comprises, or otherwise operates in connection with, an ML model and/or a deterministic algorithm, may begin when an orchestrator receives 302 job configuration information from a user. The orchestrator may then request, and receive 304, information from a quantum computing service vendor. The information received 304 may correspond with, and be responsive to, the job configuration information received 302 from the user.

Using the information received 304 from the quantum computing service vendor, and guided by the job configuration information received 302 from the user, the orchestrator may generate 306 a vendor score. The vendor score may indicate a relative level of confidence in the performance of quantum hardware and/or quantum software of the quantum computing service vendor. For example, the vendor score may quantify the relative accuracy of and, thus, a relative level of trust in, an output of quantum hardware and/or quantum software of the quantum computing service vendor.

Consistent with the foregoing, the vendor score may be employed as an input to a DCF confidence analysis 307. The DCF confidence analysis 307 may determine confidence for (i) individual elements, or nodes, of a DCF, (ii) data transiting the DCF, and/or (iii) the DCF as a whole.

The vendor score may additionally, or alternatively, be transmitted 308 to the user that submitted the job configuration information. The user may use the vendor score, and other information, to make a decision concerning whether to retain a particular quantum computing services vendor to perform the job to which the job configuration information corresponds. The user may convey a decision, or selection, as to a particular vendor, to the orchestrator, which may then receive 310 the vendor selection. The selection information from the user may then be conveyed 312 by the orchestrator to the selected vendor, and the orchestrator may connect the user and the vendor so that the vendor services can be supplied to the user.

As shown in FIG. 3, after a vendor score has been transmitted 318 to a user, the method 300 may loop back and continue to receive 302 job configuration information and/or quantum computing service information 304. In this way, the method 300 may continually update vendor scores based on user needs and/or based on vendor parameters and performance.

### E. FURTHER EXAMPLE EMBODIMENTS

Following are some further example embodiments of the invention. These are presented only by way of example and are not intended to limit the scope of the invention in any way.

Embodiment 1. A method, comprising: receiving job configuration information from a user with a quantum computing job to be performed; receiving quantum computing information from a quantum computing service vendor; generating, based on the quantum computing information, a vendor score for the quantum computing service vendor; and transmitting the vendor score to the user.

Embodiment 2. The method as recited in embodiment 1, wherein the method is performed by an orchestrator.

Embodiment 3. The method as recited in any of embodiments 1-2, wherein the vendor score indicates a relative extent to which confidence exists in a performance of a quantum computing hardware resource controlled by the vendor.

Embodiment 4. The method as recited in any of embodiments 1-3, wherein the vendor score is generated by a deterministic algorithm that uses, as inputs, the job configuration information and the quantum computing information.

Embodiment 5. The method as recited in any of embodiments 1-4, wherein the job configuration information comprises: a number of shots; and a QPU error rate.

Embodiment 6. The method as recited in any of embodiments 1-5, wherein the vendor score is also provided to a platform for analyzing, based in part on the vendor score, a confidence level concerning an aspect of a data confidence fabric.

Embodiment 7. The method as recited in any of embodiments 1-6, wherein generating the vendor score comprises disambiguating error resulting from inherent probabilistic noise of a quantum process performed by the vendor, from error which results from operation of a quantum computing hardware resource controlled by the vendor.

Embodiment 8. The method as recited in any of embodiments 1-7, wherein the vendor score enables the user to decide whether or not to select the quantum computing service vendor to perform the quantum computing job.

Embodiment 9. The method as recited in any of embodiments 1-8, wherein the vendor score is determined based in part on operation of a machine learning model which is executable to learn about a relationship between quantum execution of the quantum computing job, and a relative user satisfaction level with results of the quantum execution.

Embodiment 10. The method as recited in any of embodiments 1-9, wherein the quantum computing information concerns a QPU or vQPU operated by the quantum computing service vendor.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

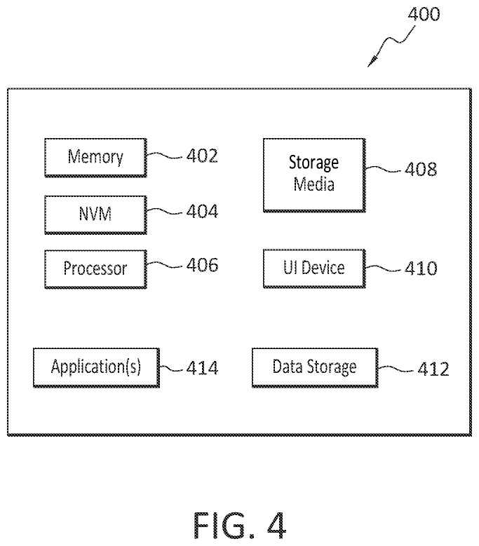

With reference briefly now to FIG. 4, any one or more of the entities disclosed, or implied, by FIGS. 1-3 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406 which may or may not comprise one or more QPUs, non-transitory storage media 408, UI (user interface) device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving job configuration information from a user with a quantum computing job to be performed;
receiving quantum computing information from a quantum computing service vendor;
generating, based on the quantum computing information, a vendor score for the quantum computing service vendor; and
transmitting the vendor score to the user.

2. The method as recited in claim 1, wherein the method is performed by an orchestrator.

3. The method as recited in claim 1, wherein the vendor score indicates a relative extent to which confidence exists in a performance of a quantum computing hardware resource controlled by the vendor.

4. The method as recited in claim 1, wherein the vendor score is generated by a deterministic algorithm that uses, as inputs, the job configuration information and the quantum computing information.

5. The method as recited in claim 1, wherein the job configuration information comprises: a number of shots; and a QPU error rate.

6. The method as recited in claim 1, wherein the vendor score is also provided to a platform for analyzing, based in part on the vendor score, a confidence level concerning an aspect of a data confidence fabric.

7. The method as recited in claim 1, wherein generating the vendor score comprises disambiguating error resulting from inherent probabilistic noise of a quantum process performed by the vendor, from error which results from operation of a quantum computing hardware resource controlled by the vendor.

8. The method as recited in claim 1, wherein the vendor score enables the user to decide whether or not to select the quantum computing service vendor to perform the quantum computing job.

9. The method as recited in claim 1, wherein the vendor score is determined based in part on operation of a machine learning model which is executable to learn about a relationship between quantum execution of the quantum computing job, and a relative user satisfaction level with results of the quantum execution.

10. The method as recited in claim 1, wherein the quantum computing information concerns a QPU or vQPU operated by the quantum computing service vendor.

11. A non-transitory storage medium having stored therein instructions that are executable by one or more hardware processors to perform operations comprising:
receiving job configuration information from a user with a quantum computing job to be performed;
receiving quantum computing information from a quantum computing service vendor;
generating, based on the quantum computing information, a vendor score for the quantum computing service vendor; and
transmitting the vendor score to the user.

12. The non-transitory storage medium as recited in claim 11, wherein the operations are performed by an orchestrator.

13. The non-transitory storage medium as recited in claim 11, wherein the vendor score indicates a relative extent to which confidence exists in a performance of a quantum computing hardware resource controlled by the vendor.

14. The non-transitory storage medium as recited in claim 11, wherein the vendor score is generated by a deterministic algorithm that uses, as inputs, the job configuration information and the quantum computing information.

15. The non-transitory storage medium as recited in claim 11, wherein the job configuration information comprises: a number of shots; and a QPU error rate.

16. The non-transitory storage medium as recited in claim 11, wherein the vendor score is also provided to a platform for analyzing, based in part on the vendor score, a confidence level concerning an aspect of a data confidence fabric.

17. The non-transitory storage medium as recited in claim 11, wherein generating the vendor score comprises disambiguating error resulting from inherent probabilistic noise of a quantum process performed by the vendor, from error which results from operation of a quantum computing hardware resource controlled by the vendor.

18. The non-transitory storage medium as recited in claim 11, wherein the vendor score enables the user to decide whether or not to select the quantum computing service vendor to perform the quantum computing job.

19. The non-transitory storage medium as recited in claim 11, wherein the vendor score is determined based in part on operation of a machine learning model which is executable to learn about a relationship between quantum execution of the quantum computing job, and a relative user satisfaction level with results of the quantum execution.

20. The non-transitory storage medium as recited in claim 11, wherein the quantum computing information concerns a QPU or vQPU operated by the quantum computing service vendor.
